(19) United States
(12) Patent Application Publication
(10) Pub. No.: US 2007/0024772 A1
(43) Pub. Date: Feb. 1, 2007

(54) Display with sub-region backlighting

(76) Inventors: Winthrop D. Childers, San Diego, CA (US); William J. Allen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/191,573

(22) Filed: Jul. 28, 2005

(51) Int. Cl. G02F 1/1335

(52) U.S. Cl. 349/68

(57) ABSTRACT

A display includes a matrix of liquid crystal elements, and a plurality of direct backlight devices. Each direct backlight device is configured to selectively illuminate a discrete portion of the matrix of liquid crystal elements associated with a backlighting sub-region with a temporal sequence of at least two illumination color lights during an image frame period.

### BACKGROUND

Liquid crystal displays (LCDs) are commonly used in a wide range of digital electronic devices, such as computers, personal digital assistants (PDAs), digital watches, clocks, game devices, electronic appliances, and so on. LCDs are desirable and becoming more popular in part because they are thin, lightweight, and consume much less power than some other display devices, such as cathode ray tubes (CRTs). The picture quality of LCDs has also improved in recent years with advances in pixel resolution, faster response time in active matrix displays, and improvements in image-generating and driving systems.

As their popularity increases, there is a demand for larger and larger LCDs. This presents a challenge for illumination. LCDs are typically illuminated in two basic ways: reflection and transmission. A reflective LCD simply provides a mirror behind the liquid crystal matrix, which reflects ambient light through the pixel array to allow viewing of the LCD displayed image. Reflective LCDs are most common in small displays that are generally used in daytime or in conditions where ambient light is expected to be adequate.

Where a display is to be used in low light conditions, or is to be viewed for long periods of time, transmissive or backlit displays are desirable. Transmissive LCD illumination systems provide light behind the LCD matrix to allow viewing. The most common LCD backlight systems are edge illumination systems that provide a light diffusion layer or light guide behind the LCD matrix, and one or more light sources, such as cold-cathode fluorescent lamps (CCFL), disposed around the edge of the light diffusion layer. The light from the lamp(s) is distributed throughout the light diffusion layer, the properties of the light diffusion layer causing the light to pass through the LCD matrix to illuminate it. Some backlit LCDs also include a mirror behind the light diffusion layer, allowing them to be illuminated reflectively when ambient light conditions are suitable, and to have a backlight capability for use in low light conditions. Such displays are common with digital watches, PDAs, cell phones, etc. On the other hand, some LCDs, such as laptop computer screens, typically include only an edge-illuminated backlight system, with no provision for reflective illumination.

Unfortunately, edge-illuminated LCDs have certain limitations in contrast, brightness, and color gamut. With respect to brightness, edge-illumination is suitable for small displays, but is inadequate for very large displays. This is generally because the light diffusion layer cannot uniformly spread and disperse the light from the cold-cathode fluorescent lamps across the entire display, creating undesired variations in brightness across the image. Additionally, because the fluorescent light source is always on, image contrast tends to be reduced. Viewing angle is also sometimes optically restricted, in part because of limitations in the overall quantity of backlight.

One approach to improving the quality of LCDs is to provide direct backlighting, rather than edge illumination. Direct backlight systems using light-emitting diodes (LEDs) as a light source have been proposed. However, there are still needs to improve brightness and/or color gamut in LCDs, even where direct backlighting is provided.

### BRIEF DESCRIPTION OF THE DRAWINGS

Various features and advantages of the invention will be apparent from the detailed description which follows, taken in conjunction with the accompanying drawings, in which:

FIG. 1 is a cross-sectional view of a portion of a prior art flat panel LCD having an indirect backlighting configuration;

FIG. 2 is a cross-sectional view of a portion of a flat panel display having direct LED sub-region backlighting, in accordance with certain exemplary implementations of the present invention;

FIG. 3 is a plan view of an array of backlighting sub-regions, in accordance with certain exemplary implementations of the present invention;

FIG. 4 is a plan view of one embodiment of an LCD matrix for a single backlighting sub-region, in accordance with certain exemplary implementations of the present invention;

FIG. 5 is an exemplary timing diagram depicting the backlight and pixel condition in one backlighting sub-region for one frame period, in accordance with certain exemplary implementations of the present invention;

FIG. 6A is a plan view of a backlighting sub-region of an LCD matrix as actuated during the first sub-frame according to the timing sequence depicted in FIG. 5, in accordance with certain exemplary implementations of the present invention;

FIG. 6B is a plan view of the backlighting sub-region of FIG. 6A as actuated during the second sub-frame according to the timing sequence depicted in FIG. 5, in accordance with certain exemplary implementations of the present invention;

FIG. 7 is a block diagram of an image processing unit for controlling a flat panel display with independently-controllable backlighting sub-regions, in accordance with certain exemplary implementations of the present invention;

FIG. 8 is a timing diagram illustrating a method for varying average backlighting intensity through varying output intensity of each illumination color light, in accordance with certain exemplary implementations of the present invention;

FIGS. 9A and 9B are exemplary timing diagrams illustrating a method for varying the average backlighting intensity through pulse width modulation, in accordance with certain exemplary implementations of the present invention; and

FIG. 10 is a timing diagram illustrating the insertion of a white color plane into a frame period, in accordance with certain exemplary implementations of the present invention.

### DETAILED DESCRIPTION

Reference will now be made to certain exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention which would occur to one skilled in the relevant art and having possession of this disclosure are to be considered within the scope of the disclosure.

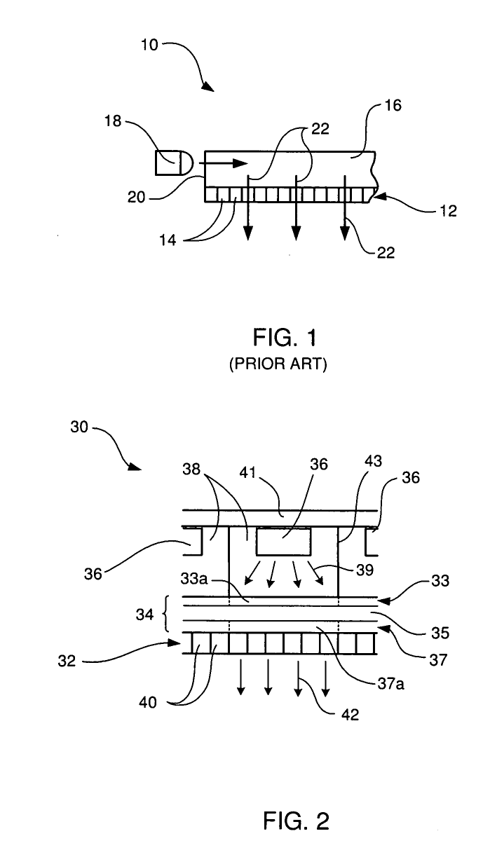

Shown in FIG. 1 is a portion of a typical edge-illuminated LCD system 10. This system 10 includes a transparent LCD matrix 12, having a plurality of pixel elements 14, overlying a light diffusion layer or light guide 16. A cold-cathode fluorescent lamp (CCFL) 18 provides light into the edge 20 of the light diffusion layer, and this light is diffused throughout the layer and redirected through the LCD matrix 12 to provide the needed illumination, as indicated by arrows 22. As noted above, edge-illuminated LCD systems tend to have certain limitations in contrast, brightness, and/or color gamut, and can be inadequate for large size LCDs. Additionally, CCFL light sources are broad-spectrum. Accordingly, colored filters (not shown) are typically arranged in a mosaic over the LCD pixels.

The present disclosure describes systems and methods that may increase the contrast, brightness and/or the color gamut of backlit displays by subdividing the display into sub-regions and providing selective color backlighting to each sub-region. Such systems and methods may be used in larger sized displays. Such systems and methods may also allow the use of various illumination colors of light, such as white, yellow, cyan, and/or other colored light(s), in addition to the more traditional red, green, and blue light.

A direct backlight device is provided for illuminating each backlighting sub-region. Each direct backlight device can be independently controlled to generate one or more illumination color lights. The illumination color lights may be generated in a specific order (e.g., a temporal sequence) to produce a desired intensity level (e.g., an average intensity value) for a given backlighting sub-region. Accordingly, the brightness and/or color gamut may be improved, as might also perceived resolution and/or energy efficiency in certain implementations.

Depicted in FIG. 2 is a cross-sectional view of a portion of a flat panel display 30 having direct sub-region backlighting. The display 30 includes a substantially transparent LCD matrix 32 overlying an optical layer 34. The display 30 is provided with direct backlighting through the optical layer 34 from a plurality of lighting devices 36. Each lighting device 36 is disposed behind the optical layer 34 and configured to generate light for a backlighting sub-region 38. Each backlighting sub-region 38 corresponds to a particular corresponding group of pixels 40 in the LCD matrix 32.

In the embodiment depicted in FIG. 2, the lighting devices 36 are attached to a common substrate 41. For example, where the lighting devices are LEDs, the substrate 41 can be a single circuit board on which each of the LEDs are surface-mounted. The sub-regions 38 comprise an area bounded by the substrate 41 and sub-region barriers 43, and associated with a contiguous group of pixels 40. The barriers 43 separate one sub-region from another, directing the light from the lighting device 36 toward its corresponding group of pixels, and helping to prevent light from one sub-region from leaking into an adjacent sub-region.

The optical layer 34 may be configured to homogenize the selected light generated by the lighting devices 36, so as to provide some level of uniformity in the backlight illumination within at least the associated sub-region 38. The optical layer can be configured in various ways, one of which is depicted in FIG. 2. In this configuration, the optical layer is a multi-layer assembly that mixes, diffuses, and expands the light. Multi-layer optics are widely used in the field of flat panel displays. The optical layer 34 in FIG. 2 includes a Fresnel lens layer 33, a diffusion layer 35, and a micro-lens layer 37. Light from the lighting device 36 is initially produced in a generally radial pattern, as shown by arrows 39 in FIG. 2. The Fresnel lens layer 33 helps to increase optical efficiency by collecting these divergent rays of light from the lighting device, and redirecting them in a direction generally perpendicular to the plane of the optical layer 34. This helps increase brightness of the display, and also initially helps provide a more uniform distribution of light across the subregion.

The Fresnel lens layer 33 can be a continuous piece of material that is provided with distinct lens regions 33a corresponding to and aligned with each lighting device 36. The individual lens regions are referred to as micro-lenses, and can be created on a continuous plate or panel of material through a micro-embossing technique. Such optical devices with micro-embossed micro-lenses are commercially available and are familiar to those of skill in the art.

The diffusion layer 35 is configured to diffuse and mix the light from the lighting device 36. This helps to more completely illuminate the entire subregion, and helps to prevent dark spots. Optical materials for diffusing light are well known by those of skill in the art, and one of skill in the art will be able to select a suitable diffusion layer for this display. The level or degree of diffusion can be controlled by selecting the properties of the material of the diffusion layer 35 so as to allow or restrict the amount of leakage or spill-over of light between adjacent subregions, as discussed in more detail below.

The micro-lens layer 37 is configured to disperse and expand the light from each subregion 38 to provide a desired viewing angle. Thus, the Fresnel lens layer 33 helps capture divergent light rays from the lighting device 36 to produce a common light direction, while the micro-lens layer 37 produces divergent rays to widen the viewing region for the display. Like the Fresnel lens layer 33, the micro-lens layer 37 can be configured as a continuous piece of optical material that is micro-embossed to provide discrete micro-lens regions 37a.

While a single micro-lens layer 37 is shown in FIG. 2, multiple micro-lens layers could be provided. For example, a first micro-lens layer could be provided with a lower frequency of lens regions (e.g. one lens region per subregion), while a second overlying micro-lens layer could be provided with a higher lens frequency (e.g. multiple lens regions per subregion). This sort of configuration can help to provide more uniform light dispersal.

The various layers of the optical layer 34 can be configured from glass, polymers, or other suitable optical materials. While the optical layer is shown as a multi-layer configuration of generally continuous materials, it will be apparent that other configurations are also possible. For example, as an alternative configuration, the optical layer could be comprised of a plurality of discrete optical elements, one for each subregion, that are joined together in an array. These discrete optical elements could each be provided with the desired optical characteristics for collecting, diffusing, and expanding the light. Following passage through the optical layer 34, the light from the lighting device 36 is directed through the LCD matrix 32 to provide the needed illumination, as indicated by arrows 42.

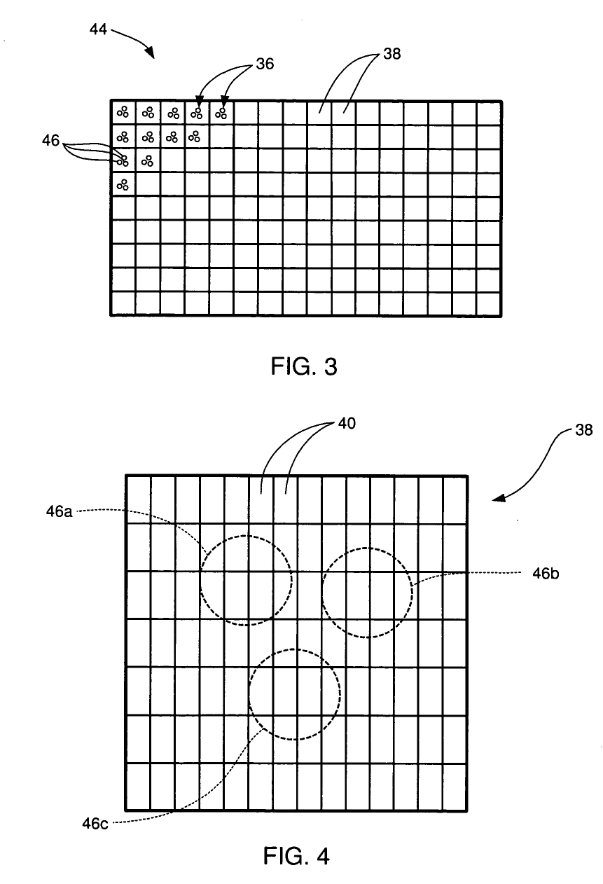

Shown in FIG. 3 is an exemplary 16×9 array 44 of backlighting sub-regions 38. Each backlighting sub-region 38 is associated with a lighting device 36 that may be independently controlled for color and intensity.

In one embodiment, the lighting device 36 in each backlighting sub-region 38 includes a group of LED light sources 46 (shown here with three LEDs) that are placed in close proximity to each other or otherwise arranged. Each LED light source 46 may be configured to generate a illumination color light for backlighting (e.g. red, green, blue, etc). In certain implementations, the lighting device 36 may include a single LED having multiple color LED elements provided on a common substrate structure. In certain implementations, the number of LEDs and/or illumination color lights may vary between lighting devices 36. It will also be apparent that other suitable lighting devices, in addition to LEDs, can also be used. For example, a laser lamp or some other type of solid state lighting device could be adapted to this system.

Whether separate LEDs or a single multiple color (e.g., RGB) LED, or some other type of lighting device, the lighting device 36 may be configured to produce illumination colors, within a range of relative output intensity for specific lengths of time.

The lighting device 36 can be independently temporally controllable to provide a sequence of illumination color light beams and an independently-controlled average intensity value for each backlighting sub-region. The LED elements can also be controlled to provide additional illumination colors, such as white, yellow, cyan, magenta, and/or the like.

It will be apparent that the number, size, shape, and/or density of backlighting sub-regions 38 in practice may be different. The backlighting sub-regions can be square as shown, or can be some other shape, such as rectangular, triangular, or hexagonal. The apparent intensity generated by each backlighting sub-region can also be varied either by varying LED intensity and/or by pulse width modulation, for each illumination color light.

Each backlighting sub-region has a corresponding array of LCD pixel elements 40. A close-up view of a single backlighting sub-region 38 of the array 44 of FIG. 3, showing one embodiment of the individual LCD pixel elements 40 and the corresponding lighting device, is illustrated in FIG. 4.

This exemplary backlighting sub-region 38 includes a 14×7 array of pixel elements 40. The lighting device includes, for example, a red LED 46a, green LED 46b, and blue LED 46c. The LCD matrix 32 of the sub-region 38 shown in FIG. 4 is of a “fully populated” LCD panel. Each of the pixel elements 40 has an ON/OFF state. Each pixel element 40, is capable of displaying the illumination color light depending on its ON/OFF state. In this example, a pixel element 40 may display a red, green, or blue color and/or possibly other illumination colors, such as yellow, cyan, magenta, or white.

The color lights output by the lighting device may be considered as representing a low resolution image when compared to the LCD matrix, which essentially selectively masks the emitted light beams to create a higher resolution displayed image.

The optical layer 34 (in FIG. 2) assures that each illumination color light substantially uniformly covers at least the pixel elements 40 corresponding to a particular backlighting sub-region 38. The optical layer 34 can also be designed to limit light leakage between adjacent backlighting sub-regions 38, or can be designed to selectively allow leakage, as desired.

In order to display colors at a spatial frequency higher than the backlighting sub-region density (that is, to provide a final image having a resolution greater than the resolution of the backlight array), the LEDs 46 may be operated sequentially within each backlighting sub-region 38 to allow the display of multiple colors within a single sub-region. This allows the relatively low resolution array of LEDs to address a high resolution of pixel elements 40 without the need for color filters over the LCD pixel elements.

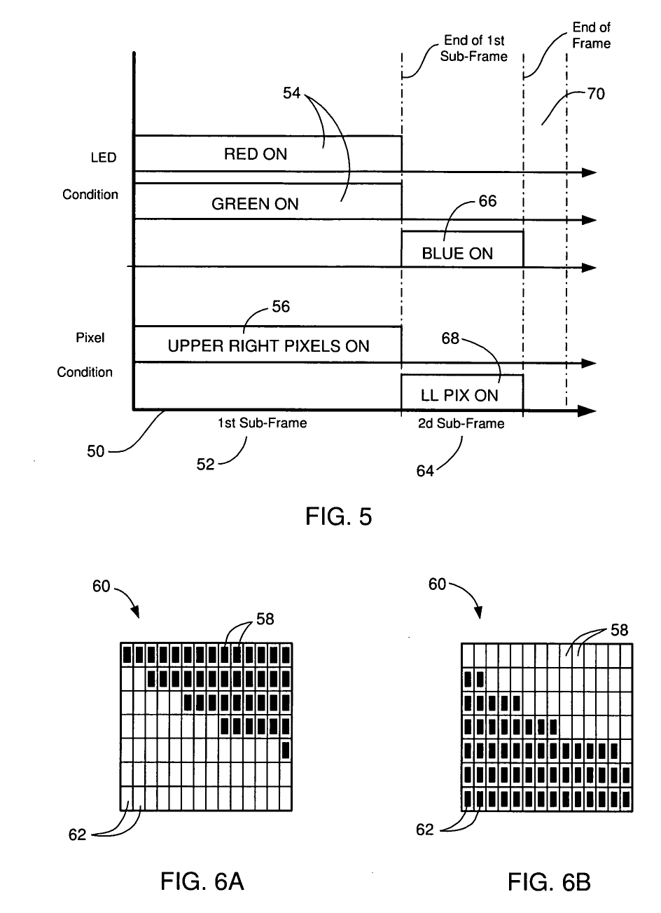

To generate more than one color within a backlighting sub-region 38, a time period such as a frame period is divided into a number of smaller duration sequential time periods, referred to herein as sub-frames, with a particular illumination color being generated during each sub-frame, and a particular subset of pixels 40 actuated to provide that color in a given pattern. A timing diagram showing one example of how this may be done is provided in FIG. 5.

This particular timing diagram depicts the backlight and pixel conditions associated with one backlighting sub-region for one frame period wherein bright yellow is to be displayed in the upper right portion of the sub-region's pixels, and dim blue is to be displayed in the lower left portion of the sub-region's pixels. The horizontal axis 50 represents time, and the upper regions 54, 66 are state diagrams indicating when the red, green, and blue LEDs 46a-c are ON (i.e., emitting light). The two bottom regions 56, 68 depict which of the sub-region's pixels are activated (e.g., ON state) to display the proper color.

During the first sequential color sub-frame 52, the red and green LEDs are ON, as indicated at 54, combining to form yellow light, and the upper right pixels are also ON, as indicated at 56. As depicted in FIG. 6A, during this sub-frame period, the upper right pixels 58 of the LCD 60 for this backlighting sub-region appear yellow, and the lower left pixels 62 are OFF and hence display no color at all. Referring back to FIG. 5, during the second sequential color sub-frame period 64, the red and green LEDs are OFF while the blue LED is ON, as indicated at 66, and the lower left pixels are ON, as indicated at 68, while the upper right pixels are OFF. As depicted in FIG. 6B, during this sub-frame period the lower left pixels 62 will be on and appear blue, while the upper right pixels 58 are OFF and hence transmit no color. Because each sub-frame is a division of a single frame period, which itself is of very short duration, all colors produced during the frame period (yellow and blue in this example) seem to appear simultaneously to a viewer, giving the illusion that all colors of the higher-resolution image are present at the same time.

While the timing diagram of FIG. 5 depicts an image frame divided into two sub-frames, it will be apparent that any number of sub-frames can be provided, depending upon the transition speed of the LED and LCD elements. For example, where five different colors are to be displayed in a single backlighting sub-region during a given frame, a backlight and pixel sequence comprising five sub-frames can be provided.

The use of backlight elements in a temporally sequenced manner also allows other features to be included, such as a blanking period. One negative aspect of some LCDs is the occasional appearance of motion artifacts. For example, in a video scene with high detail and rapid action, the image signal can change at a rate that approaches or exceeds the maximum transition rate of the LCD matrix. The result is that certain pixels or groups of pixels can lag behind the signal, leaving a visible artifact of a prior image frame in a subsequent frame. This sort of problem is solved in CRTs with the insertion of a blank period—that is, a brief time between image frames wherein all pixels are turned OFF. However, with a continuously illuminated edge lighting system, typical LCDs do not allow the insertion of blanking periods.

Advantageously, by using LED lighting sources, the present backlight system can insert blanking periods to help eliminate motion artifacts. One application of this feature is depicted in the timing diagram of FIG. 5. At the end of each frame period, a brief blank period 70 can be inserted, in which the LED elements are OFF. This blanking period may be provided to cover transitions of LCD pixel elements, so as to reduce or eliminate motion artifacts. That is, the display goes blank for a brief time period, then re-illuminates in the new image state. The span of the blank period is so brief that the human eye does not detect it, but it operates to greatly increase the sharpness of the picture. This feature is possible with LEDs because LEDs can be very precisely controlled to illuminate or cease illumination in very small time increments. This sort of rapid light control is not possible with CCFL edge illumination systems.

Blanking periods can also be inserted between color sub-frames. For example, if a particular pixel or group of pixels associated with a particular sub-region were to be maximum green with a tiny bit of red and no yellow, a blanking period can be inserted between the green and red sub-frames, giving the LCD additional time to change state.

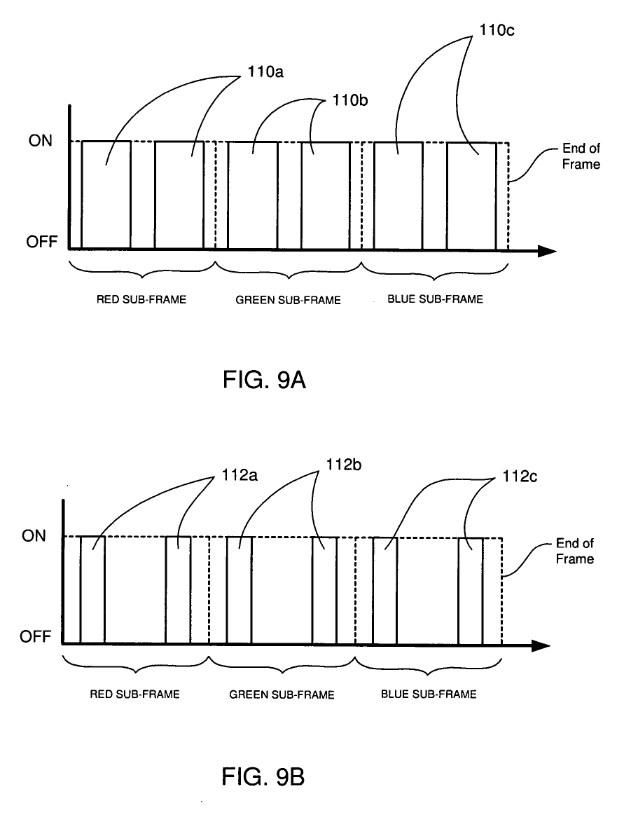

A configuration with blanking periods between color sub-frames is depicted in FIG. 9A, wherein a blanking period 111a is inserted between the red sub-frame 110a and the green sub-frame 110b, and a blanking period 111b is inserted between the green sub-frame and the blue sub-frame 110c.

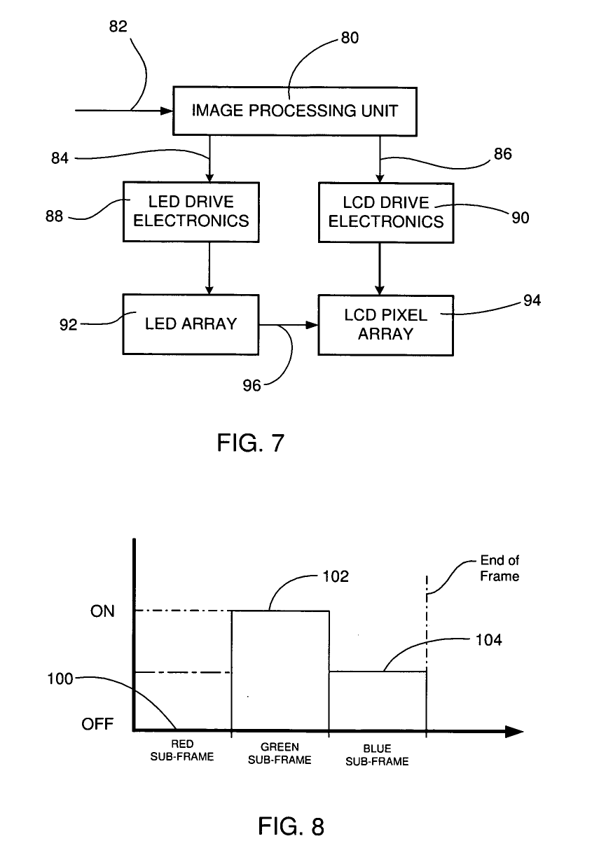

In order to provide the sequential activation of the LED and LCD elements associated with each sub-region, certain unique control features are required. A system block diagram for controlling the independently-controlled sub-region backlighting system is depicted in FIG. 7.

An IPU (image processing unit) 80 is configured to receive a video signal (represented by arrow 82) defining an image, and, in response, to generate control signals (represented by arrows 84, 86) for the LED and LCD drive electronics, 88, 90. The LED and LCD drive electronics in turn provide signals to the LED array 92 and LCD pixel array 94, respectively. Accordingly, the LED array provides a low resolution image (represented by arrow 96), which is refined by the LCD array.

The IPU 80 includes various components such as a digitizer, video processor, degamma lookup tables chip, etc. as required. The IPU can be a single application specific integrated circuit (ASIC) incorporating all the functions described herein, or its functions may be distributed among a number of chips that each provide portions of the functionality.

The IPU 80 can include a frame-by-frame analysis function that analyzes an entire image frame and/or sub-regions of the image frame to optimize control signals for the drive electronics. The analysis function may be configured to generate information indicative of a pixel intensity characteristic for each of the sub-regions of the image frame. In response to the information, the image processing unit generates control signals for the sub-regions such that there is an advantageous variation in backlighting color generation from one backlighting sub-region to another.

As a first example, the pixel intensity characteristic can be a histogram of average luminance (averaged over the frame period for each pixel). As a second example, the pixel intensity characteristic can be a maximum pixel luminance averaged over the frame period. As a third example, the pixel intensity characteristic can include a maximum value for pixel intensity for each of a set of one or more illumination colors. In a fourth example, the pixel intensity characteristic can be a histogram of average intensity (averaged over the frame period for each pixel) for each illumination color. Other variants are also possible.

Using the pixel intensity characteristic information, the image processing unit is configured to vary a characteristic of the sequential backlighting from one sub-region to another. This can be done in many ways. Options for varying the backlighting sequence include: (1) varying the average intensity of the LEDs; (2) providing relative and absolute weighting of the duration of the illumination color planes; (3) varying the illumination color sequence; and/or (4) varying the color selection. Each of these options are discussed below, along with specific examples.

The present discussion refers to “color sub-frames” and “color planes”. For a given backlighting sub-region a color plane is a contiguous time period during which a particular illumination color light is being cast upon the sub-region's LCD pixels. During a frame period, there may be several color planes for a given illumination color. A color sub-frame, however, includes all of the time periods during which a particular illumination color light is cast upon the sub-region's LCD pixels. If the color sub-region is contiguous (as in FIG. 8), then the color sub-frame is also a color plane. On the other hand, the color sub-frame may include multiple color planes that are not contiguous (as shown in FIGS. 9A and 9B). For example, there may be multiple non-contiguous green color planes distributed throughout a frame period, in which case the combination of the multiple non-contiguous green color planes are referred to as the green sub-frame.

With respect to the first option, varying the average intensity of the LEDs involves varying the average intensity of backlighting for each sub-region across the flat panel device. This can be done by varying the output intensity of the backlight (that is, the output intensity of the LED backlight devices) from backlighting sub-region to backlighting sub-region. Alternatively the duty cycle of the respective LEDS (i.e., the percentage of the total frame period during which the LEDS are in an ON state) can be varied from one backlighting sub-region to another. As another alternative, a combination of duty cycle and intensity can both be adjusted to achieve the desired average power output for an LED. Indeed, this approach can be applied to many of the embodiments disclosed herein.

As a specific example of this option, where the pixel characteristic intensity information for each backlighting sub-region is a histogram of the pixel luminance averaged over the frame period, a backlighting sub-region having bright pixels (meaning a histogram skewed toward higher luminance) can utilize a color generation sequence similar to that illustrated in FIG. 9A. As shown in FIG. 9A, the total ON time of the LEDS, being the cumulative horizontal width of the vertical bars 110a, 110b, and 110c, is relatively high. This represents a high duty cycle. On the other hand, a backlighting sub-region having dimmer pixels (meaning a histogram skewed toward lower luminance) would utilize a color generation sequence more like that depicted in FIG. 9B, wherein the LEDS have a relatively lower duty cycle, represented by the smaller cumulative width of the narrower vertical bars 112a, 112b, and 112c.

With respect to the second option, variation in weighting of color planes involves varying the average intensity of each illumination color. This can be done by varying the intensity of the LEDS, by pulse width modulation and/or by varying the duty cycle.

As a specific example of the second option, where the pixel characteristic intensity information is a maximum pixel intensity for each of red, green, and blue color components for each pixel in the sub-region, the color planes being generated can be as depicted in FIG. 8. For this example, the maximum value for red is zero, green is maximized, and blue is low. Based upon this information, an LED ON/OFF sequence for the backlighting sub-region is then selected and the maximum value (i.e. intensity) for red (indicated at 100) is zero, green (indicated at 102) is maximized, and blue (indicated at 104) is low, providing the desired color at the desired intensity. It will be apparent that this is just one example of varying the intensity of individual illumination colors.

One additional factor is apparent by comparing FIG. 8 with FIGS. 9A and 9B. In FIG. 8, the individual color planes (represented by bars 100, 102, 104) are depicted as comprising a single light pulse that temporally illuminates all of the LCD pixels in the backlighting sub-frame. As an alternative to this approach, each color plane can comprise multiple separate pulses (e.g. bars 110a-c), as depicted in FIG. 9A. Furthermore, while two pulses are shown in each color plane in FIG. 9A, the number of pulses per color plane can vary from this number. The inventors believe that separate pulses may help to reduce potential visual artifacts.

As another means of varying the weighting of the color planes, the duration of the color planes can be varied. Though not depicted in FIG. 8, the green sub-frame 102 could have maximum width, while the blue sub-frame 104 has a lesser width. Additionally, in this example the red sub-frame 100 can be eliminated entirely if there is no red component to be displayed.

While it is depicted in some of the figures that each illumination color sub-frame is repeated once and has approximately an equal duration during a frame period, this does not have to be the case. There may be frame periods having repeated color planes of the same illumination color. For example, the system can be configured to cycle through a sequence of illumination colors more than one time per frame, such as a sub-frame sequence RGBRGB, wherein each sub-frame has a duration of 1/60 second.

In addition, the color planes and/or color sub-frames may vary in duration for a particular frame period. This can be one in a manner that is optimized based upon the pixel intensity characteristic information. An example of this approach is depicted in FIG. 9A, wherein the red and green sub-frames, 110a, 110b, are of a shorter duration than the blue sub-frame 110c because of the insertion of the blanking periods 111.

The third option, varying the illumination color sequence, can also be useful. The ordering or the number of color sub-frames can be varied to optimize contrast and to avoid visual artifacts. For example, for a very bright portion of an image it may be desirable to have more than one green sub-frame (since green contributes more to perceived brightness than red or blue). During a frame period, the color planes may be RGBG for example, where the green color plane is repeated. For a dimmer frame period, RGB may be sufficient. It will be apparent that many other variations in the number and order of color sequences can be used.

The option of varying illumination color selection can be dependent upon the requirements of the image being generated. For example, illumination colors such as white, yellow, cyan, and magenta can be utilized in addition to, or instead of, red, green, and blue. This is done during a sub-frame by energizing different combinations of the RGB LED elements simultaneously. For example, energizing red at 100% and green at 50% can produce an orange-like color that can be used as an additional illumination color. These exemplary illumination colors can be generated as shown in the following table:

| Illumination color | R-State | G-State | B-State |
|---|---|---|---|
| White | ON | ON | ON |
| Yellow | ON | ON | OFF |
| Magenta | ON | OFF | ON |
| Cyan | OFF | ON | ON |

As an example, to generate a yellow sub-region during a sub-frame period, red and green would be ON. The maximum intensity of the yellow sub-region would determine the duty cycle of the red and green LEDS during the sub-frame period. Intermediate illumination colors such as orange can also be generated via the ratio of RGB duty cycles.

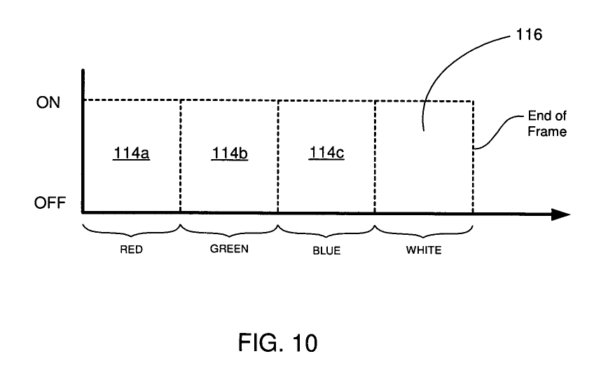

The color plane sequence depicted in FIG. 10 is an example of varying the illumination color selection wherein a white color plane is added. In this example, the red, green, and blue color planes, 114a, 114b, and 114c, respectively, are followed by a white color plane 116 (wherein all the LEDS are turned ON to produce white light). This sequence would be referred to as RGBW. This color plane sequence can be used to enhance brightness, or to provide the white component of color values for pixels. Additionally, while the RGBW color planes shown in FIG. 10 are approximately of the same duration, the relative lengths (i.e. time length) of the sub-frames can vary. For example, in an extreme case, such as a black sky with very bright pastel celestial objects, the white plane could dominate the frame period.

It will be understood that the white component for each pixel is equal to min(R, G, B) wherein R,G,B are red, green, and blue components respectively for a pixel. Where this component is large in relation to the overall brightness (a highly unsaturated pixel color) then it makes sense to utilize a white plane.

One can also define other components, such as a yellow component as min(R, G). In the case where red and green are approximately equal and there is no blue component, one can say that the object is “yellow”, and the best way to generate the color is with yellow color planes. Other color planes, such as cyan, magenta, orange, etc., can be defined in a like manner.

Another consideration with respect to the backlight control is color generation methods at boundaries of backlighting sub-regions. If two adjacent frames have drastically different color plane sequences or intensities, boundaries of the sub-regions may become noticeable. This is generally considered undesirable. One way to avoid this is to make gradual changes from one sub-region to another. This can be done by having a maximum “slew rate” so as to establish a “best fit” pattern. The general rule is that the pattern is generated based upon the overall histogram for the image frame. If the histogram shows a majority of sub-regions being dim (low average luminance), for example, then the majority of sub-regions will have attenuated color planes (i.e. short pulse width or low duty cycle) such as is depicted with respect to FIG. 9B. The sub-regions would then be “slewed” in directions of increasing average intensity at a rate that does not produce visual artifacts across backlighting sub-region boundaries.

Another way to help reduce the appearance of boundaries between sub-regions is to allow some overlap or spillage of light between adjacent backlighting sub-regions. That is, the optical layer 34 of the display can be configured to allow some amount of light from one sub-region to illuminate some pixels at the edge of an adjacent backlighting sub-region, and vice versa. In the embodiment of FIG. 2, this can be accomplished by carefully selecting the light diffusion characteristics of the diffusion layer 35 to allow only a desired level of diffusion, so that light from one sub-region can illuminate an edge portion of an adjacent sub-region, but only to a selected degree.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A display comprising:
a matrix of liquid crystal elements; and
a plurality of direct backlight devices, each direct backlight device being configured to selectively illuminate a discrete portion of said matrix of liquid crystal elements associated with a backlighting sub-region with a temporal sequence of at least two illumination color lights during an image frame period.

2. A display in accordance with claim 1, further comprising:
an optical layer, operatively arranged between the plurality of direct backlight devices and the matrix of liquid crystal elements, and configured for each backlighting sub-region to direct at least a portion of the illumination color lights from the direct backlight device to the corresponding discrete portion of said matrix of liquid crystal elements.

3. A display in accordance with claim 1, wherein each sub-region provides backlighting for a discrete subset of pixel elements of the liquid crystal matrix.

4. A display in accordance with claim 1, wherein the temporal sequence comprises a first sub-frame, during which a first illumination color is generated, and a second sub-frame, during which a second illumination color is generated.

5. A display in accordance with claim 4, wherein a first portion of the subset of pixel elements are in an ON state during the first sub-frame, and a second portion of the subset of pixel elements are in an ON state during the second sub-frame.

6. A display in accordance with claim 4, wherein the temporal sequence further comprises a blank period inserted between the first sub-frame and the second sub-frame, wherein substantially no light is generated by the backlight device.

7. A display in accordance with claim 1, further comprising a blank period following the image frame period, wherein substantially no light is generated by the backlight device.

8. A display in accordance with claim 1, wherein the temporal sequence of illumination colors is selected from the group consisting of red, green, blue, white, cyan, yellow, and magenta.

9. A display in accordance with claim 1, wherein the backlight device comprises an LED device.

10. A display in accordance with claim 9, wherein the LED device comprises an array of LED elements configured to provide multiple illumination colors at a selected intensity level.

11. A display, comprising:
a direct-view spatial light modulator having an array of pixel elements; and
an array of backlighting elements, each backlighting element being associated with a sub-region of the array of pixel elements and configured to provide a temporal sequence of illumination colored light to the associated sub-region of the array of pixel elements.

12. A display in accordance with claim 11, wherein each sub-region provides backlighting for a discrete subset of the pixel elements.

13. A display in accordance with claim 12, wherein the temporal sequence comprises a first sub-frame, during which a first illumination color is generated, and a second sub-frame, during which a second illumination color is generated.

14. A display in accordance with claim 13, further comprising a blank period, inserted into the temporal sequence adjacent to at least one of the sub-frames, wherein substantially no light is generated by the backlighting element associated with a selected sub-region.

15. A display in accordance with claim 13, wherein a first portion of the subset of pixel elements are in an ON state during the first sub-frame, and a second portion of the subset of pixel elements are in an ON state during the second sub-frame.

16. A display in accordance with claim 11, wherein the temporal sequence of illumination colors is selected from the group consisting of red, green, blue, white, cyan, yellow, and magenta.

17. A display device, comprising:
a first higher resolution light modulator, comprising an array of pixel elements configured to provide image information; and
a second lower resolution color light modulator, configured to illuminate the first higher resolution light modulator, comprising an array of independently-addressable color lighting devices, each lighting device configured to provide a temporal sequence of illumination colored backlighting to a sub-region of the higher resolution light modulator, in synchronization with selective actuation of the pixel elements of the higher resolution light modulator.

18. A display device in accordance with claim 17, wherein the first higher resolution image modulator comprises an active matrix LCD display

19. A display device in accordance with claim 17, wherein the second lower resolution color light modulator comprises an array of multi-color LED devices.

20. A display device in accordance with claim 17, wherein the temporal sequence comprises a plurality of sub-frames, each sub-frame representing a temporal portion of an image frame, the lighting devices in each sub-region being configured to generate discrete illumination colors during each sub-frame.

21. A method for displaying an image, comprising the steps of:
dividing an image signal for a single image frame into spatially discrete portions corresponding to a plurality of discrete backlight sub-regions of a direct-view spatial light modulator;
subdividing each spatially discrete portion of the image signal into temporally discrete sub-frames characterized by an illumination color across a range of pixel elements associated with the corresponding backlight sub-region;
modulating the spatial light modulator to sequentially actuate each range of pixel elements during each sub-frame; and
modulating a color backlight device in each sub-region for each sub-frame to sequentially provide the illumination color for each range of pixels for each sub-frame.

22. A method in accordance with claim 21, wherein the step of modulating the color backlight device in each sub-region further comprises generating a first illumination color during a first sub-frame, and generating a second illumination color during a second sub-frame.

23. A method in accordance with claim 21, wherein the step of modulating the color backlight device in each sub-region comprises modulating at least one of the intensity, pulse width, duration, duty cycle, and sequence of color generated by the backlight device.

24. A method in accordance with claim 21, further comprising the step of providing a blank period between consecutive image frames, during which the backlight device generates substantially no light.

25. A method in accordance with claim 21, further comprising the step of providing a blank period between consecutive sub-frames, during which the backlight device generates substantially no light.

26. A method for displaying an image, comprising the steps of:
analyzing an image signal to determine illumination colors and intensities for an image frame for a plurality of spatial sub-regions of a display;
generating a control signal for each sub-region based upon the image signal, the control signal being configured to temporally sequentially actuate a subset of pixels associated with the sub-region during a frame period; and
generating a control signal for a backlight device associated with the sub-region of pixels, so as to temporally sequentially actuate the backlight device to provide a desired illumination color for each subset of pixels for each sub-frame.

27. A method in accordance with claim 26, wherein the control signal is configured to produce a blank period, during which the backlight device generates substantially no light, adjacent to at least one of the image frame and a selected sub-frame.
